(19) United States
(12) Patent Application Publication
(10) Pub. No.: US 2023/0232116 A1
(43) Pub. Date: Jul. 20, 2023

(54) VIDEO CONVERSION METHOD, ELECTRONIC DEVICE, AND NON-TRANSITORY COMPUTER READABLE STORAGE MEDIUM

(71) Applicant: Beijing Baidu Netcom Science Technology Co., Ltd., BEIJING (CN)

(72) Inventors: Qi Zhang, Beijing (CN); Dongliang He, Beijing (CN); Xin Li, Beijing (CN)

(21) Appl. No.: 18/156,187

(22) Filed: Jan. 18, 2023

(30) Foreign Application Priority Data
Jan. 19, 2022 (CN) 202210062046.0

(51) Int. Cl. H04N 23/741; G06T 3/40; G06T 5/00; G06T 5/50

(52) U.S. Cl. CPC H04N 23/741; G06T 3/40; G06T 5/007; G06T 5/50; G06T 2207/20081; G06T 2207/20208; G06T 2207/20221

(57) ABSTRACT

Provided are a video conversion method, an electronic device and a non-transitory computer readable storage medium. The implementation scheme is as follows: a to-be-converted SDR video is acquired; one frame is extracted from the to-be-converted SDR video to serve as a current SDR image, the current SDR image is input into a parameter predictor and a generator, and an adjustment parameter corresponding to the current SDR image is output from the parameter predictor; the adjustment parameter corresponding to the current SDR image is input into the generator, and an HDR image corresponding to the current SDR image is output from the generator; and the operation described above is repeatedly performed until frames are converted into HDR images each of which corresponds to a respective frame of the frames; and a corresponding HDR video is generated based on the HDR images corresponding to the frames.

### CROSS-REFERENCE TO RELATED APPLICATION(S)

This application claims priority to Chinese Patent Application No. 202210062046.0 filed Jan. 19, 2022, the disclosure of which is incorporated herein by reference in its entirety.

### TECHNICAL FIELD

The present disclosure relates to the field of artificial intelligence technologies, further, computer vision and deep learning technologies, and particularly, a video conversion method, an electronic device, and a non-transitory computer readable storage medium.

### BACKGROUND

With the rapid development of ultra-high-definition video technologies, people have an increasing demand for an ultra-high-definition video. However, excellent ultra-high-definition contents on the market are still scarce. Therefore, the existing high-definition or low-definition resources need to be converted into ultra-high-definition videos through a technical means. This contains a conversion of a standard dynamic range (SDR) video into a high dynamic range (HDR) video. The SDR video has a color gamut of BT709 and a bit depth of 8 bit, while the HDR video has a wider color gamut (BT2020) and a deeper bit depth (10 bit) than the SDR video. Therefore, the HDR video subjectively has brighter white, darker black, and more beautiful color appearance than the SDR video, whereby more stunning visual experience is brought to audiences.

In the related art, three main manners exist to reconstruct the HDR video, which are respectively as follows. (1) An HDR image is reconstructed based on fusion of multiple images with different exposure. This scheme may reconstruct multiple images with different exposure only in one scene. However, in practice, the SDR image which is needed to be reconstructed is only one image, but the multiple images with different exposure do not exist. Therefore, in an actual scene, this scheme is not practical. (2) The HDR image is reconstructed based on a single frame SDR image. This scheme mainly solves the deficiency of the scheme (1), and may reconstruct the HDR video from a single frame image. However, the reconstruction effect is relatively poor because the acquired information is less. In addition, the scheme (2) adopts the same scheme for images with different exposure degrees in an actual scene. For example, the same scheme is used for reconstruction of both an overexposed image and an underexposed image, and the effect is necessarily poor. (3) The HDR video is reconstructed based on the SDR video. This scheme is similar to the scheme (2). However, the scheme (3) may process each frame in the video on the basis of the scheme (2). Therefore, although the scheme (3) can solve the conversion from SDR to HDR of the video, the problem of the scheme (2) still exists for each frame, which causes the video to jitter in a time sequence.

### SUMMARY

The present disclosure provides a video conversion method, an electronic device, and a non-transitory computer readable storage medium.

In a first aspect, the present application provides a video conversion method. The method includes the following. A to-be-converted SDR video is acquired; one frame is extracted from the to-be-converted SDR video to serve as a current SDR image, the current SDR image is input into a parameter predictor and a generator which are pre-trained, and an adjustment parameter corresponding to the current SDR image is output from the parameter predictor; the adjustment parameter corresponding to the current SDR image is input into the generator, and an HDR image corresponding to the current SDR image is output from the generator; an operation of extracting the current SDR image is repeatedly performed until frames in the to-be-converted SDR video are converted into HDR images each of which corresponds to a respective frame of the frames; and an HDR video corresponding to the to-be-converted SDR video is generated based on the HDR images.

In a second aspect, an embodiment of the present application provides an electronic device. The electronic device includes one or more processors and a memory configured to store one or more programs. The one or more programs, when executed by the one or more processors, cause the one or more processors to perform: acquiring a to-be-converted standard dynamic range (SDR) video; extracting one frame from the to-be-converted SDR video to serve as a current SDR image, inputting the current SDR image into a parameter predictor and a generator which are pre-trained, and outputting an adjustment parameter corresponding to the current SDR image from the parameter predictor; inputting the adjustment parameter corresponding to the current SDR image into the generator, and outputting a high dynamic range (HDR) image corresponding to the current SDR image from the generator; and repeatedly performing an operation of extracting the current SDR image until frames in the to-be-converted SDR video are converted into HDR images each of which corresponds to a respective frame of the frames; and generating an HDR video corresponding to the to-be-converted SDR video based on the HDR images.

In a third aspect, an embodiment of the present application provides a non-transitory computer readable storage medium storing a computer instruction. The computer instruction is configured to cause a computer to perform: acquiring a to-be-converted standard dynamic range (SDR) video; extracting one frame from the to-be-converted SDR video to serve as a current SDR image, inputting the current SDR image into a parameter predictor and a generator which are pre-trained, and outputting an adjustment parameter corresponding to the current SDR image from the parameter predictor; inputting the adjustment parameter corresponding to the current SDR image into the generator, and outputting a high dynamic range (HDR) image corresponding to the current SDR image from the generator; and repeatedly performing an operation of extracting the current SDR image until frames in the to-be-converted SDR video are converted into HDR images each of which corresponds to a respective frame of the frames; and generating an HDR video corresponding to the to-be-converted SDR video based on the HDR images.

It should be understood that the contents described in this section are not intended to identify key or critical features of the embodiments of the present disclosure, nor intended to limit the scope of the present disclosure. Other features of the present disclosure will be readily understood from the following description.

### BRIEF DESCRIPTION OF DRAWINGS

The drawings are intended to provide a better understanding of this scheme and are not to be construed as limiting the present disclosure, in which:

FIG. 1 is a first flowchart of a video conversion method according to an embodiment of the present application;

FIG. 2 is a schematic structural diagram of a video conversion model according to an embodiment of the present application;

FIG. 3 is a schematic structural diagram of a generator according to an embodiment of the present application;

FIG. 4 is a second flowchart of a video conversion method according to an embodiment of the present application;

FIG. 5 is a third flowchart of a video conversion method according to an embodiment of the present application; and

FIG. 6 is a schematic structural diagram of a video conversion apparatus according to an embodiment of the present application; and

FIG. 7 is a block diagram of an electronic device for implementing a video conversion method of an embodiment of the present application.

### DETAILED DESCRIPTION

Exemplary embodiments of the present disclosure are described below with reference to the accompanying drawings, in which various details of embodiments of the present disclosure are included to assist understanding, and which are to be considered as merely exemplary. Therefore, those of ordinary skill in the art will recognize that various changes and modifications of the embodiments described herein may be made without departing from the scope and spirit of the present disclosure. Also, descriptions of well-known functions and structures are omitted in the following description for clarity and conciseness.

### Embodiment One

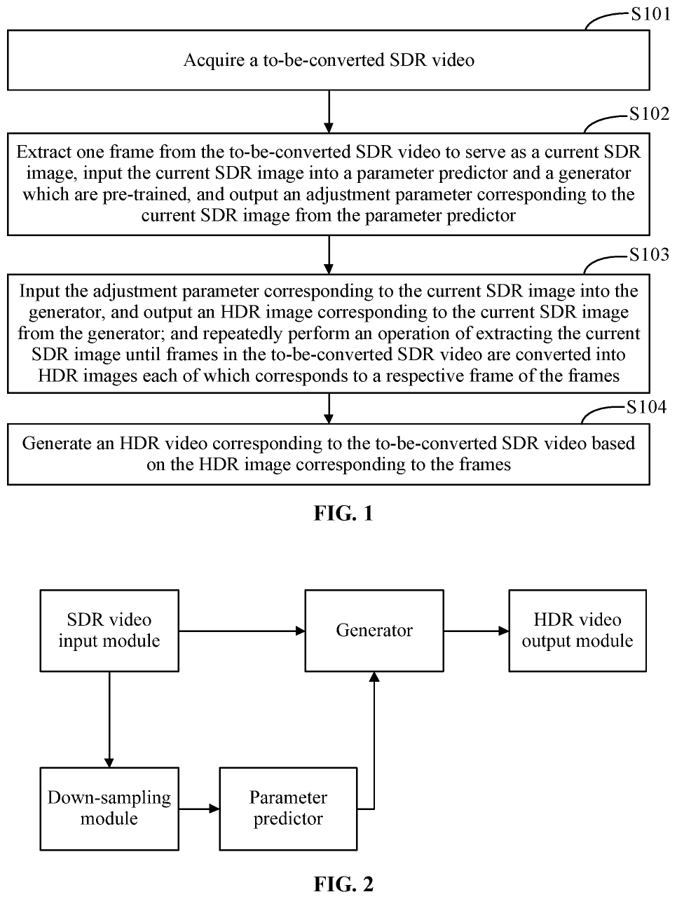

FIG. 1 is a first flowchart of a video conversion method according to an embodiment of the present application. The method may be executed by a video conversion apparatus or an electronic device, the video conversion apparatus or the electronic device may be implemented in a manner of software and/or hardware, and the video conversion apparatus or the electronic device may be integrated in any smart device with a network communication function. As shown in FIG. 1, the video conversion method may include the following steps.

In S101, a to-be-converted SDR video is acquired.

In this step, the electronic device may acquire the to-be-converted SDR video. In an embodiment, the SDR video consists of SDR pictures, and the SDR video may be independently generated directly in an SDR format.

In S102, one frame is extracted from the to-be-converted SDR video to serve as a current SDR image, the current SDR image is input into a parameter predictor and a generator which are pre-trained, and an adjustment parameter corresponding to the current SDR image is output from the parameter predictor.

In this step, the electronic device may extract one frame from the to-be-converted SDR video to serve as the current SDR image, input the current SDR image into the parameter predictor and the generator which are pre-trained, and output the adjustment parameter corresponding to the current SDR image from the parameter predictor. The parameter predictor in the embodiment of the present application may be a neural network, and the generator may also be a neural network.

In S103, the adjustment parameter corresponding to the current SDR image is input into the generator, and an HDR image corresponding to the current SDR image is output from the generator; and an operation of extracting the current SDR image is repeatedly performed until frames in the to-be-converted SDR video are converted into HDR images corresponding to the a respective frame of the frames.

In this step, the electronic device may input the adjustment parameter corresponding to the current SDR image into the generator, and output the HDR image corresponding to the current SDR image from the generator; and repeatedly perform the operation of extracting the current SDR image until the frames in the to-be-converted SDR video are converted into the HDR images each of which corresponds to a respective frame of the frames. In an embodiment, the electronic device may first input the current SDR image into a down-sampling module, downscale the current SDR image to an image of a predetermined size through the down-sampling module, then input the image of the predetermined size into the parameter predictor, output a predicted value of an adjustment parameter corresponding to the image from the parameter predictor, input the predicted value of the adjustment parameter into the generator, and then the generator may output the HDR image corresponding to the current SDR image based on the current SDR image and the predicted value of the adjustment parameter.

In S104, an HDR video corresponding to the to-be-converted SDR video is generated based on the HDR images corresponding to the frames.

In this step, the electronic device may generate the HDR video corresponding to the to-be-converted SDR video based on the HDR images corresponding to the frames. In an embodiment, the electronic device may stitch the HDR images corresponding to the frames to obtain the HDR video corresponding to the SDR video.

FIG. 2 is a schematic structural diagram of a video conversion model according to an embodiment of the present application. As shown in FIG. 2, the model may include an SDR video input module, a down-sampling module, a parameter predictor, a generator, and an HDR video output module. The SDR video input module is configured to input a current SDR image into the down-sampling module and the generator, respectively. The down-sampling module is configured to downscale the current SDR image to an image of a predetermined size and then input the image of the predetermined size into the parameter predictor. The parameter predictor is configured to output an adjustment parameter corresponding to the image of the predetermined size based on the image of the predetermined size and input this adjustment parameter into the generator. The generator is configured to generate an HDR image corresponding to the current SDR image based on the current SDR image and the adjustment parameter, and output the HDR image corresponding to the current SDR image from the HDR video output module.

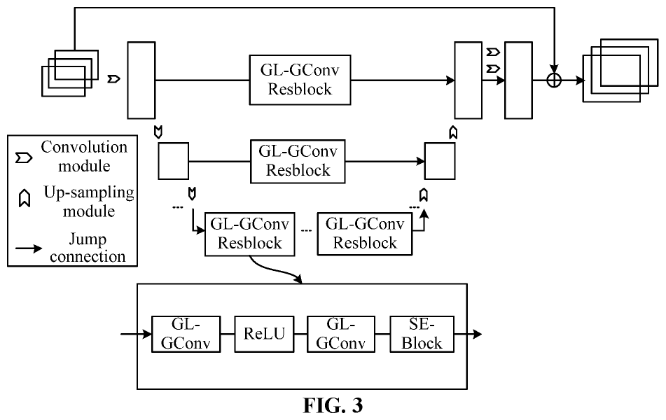

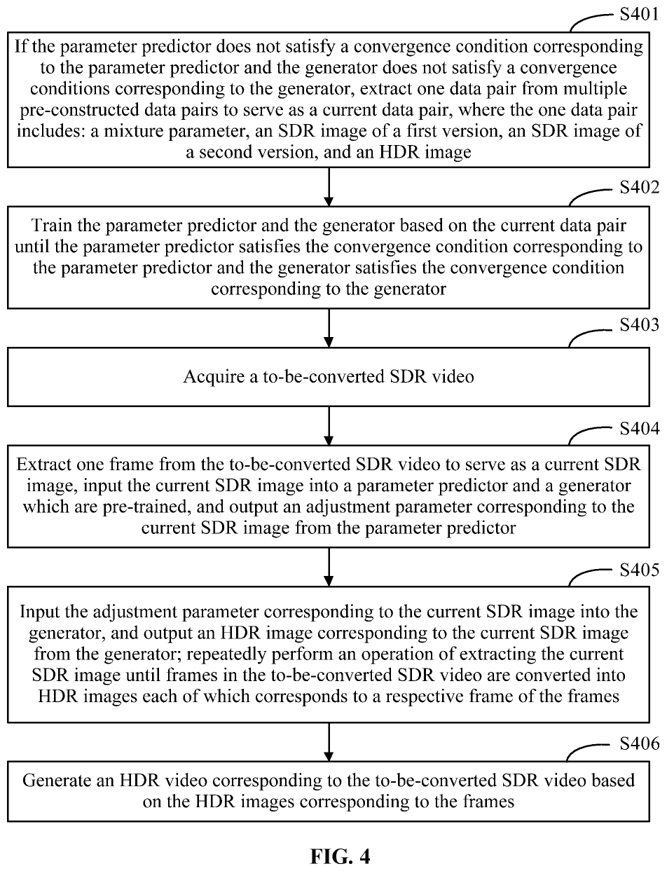

FIG. 3 is a schematic structural diagram of a generator according to an embodiment of the present application. As shown in FIG. 3, the leftmost side of FIG. 3 is a to-be-converted SDR image, it can be seen that there are multiple convolution modules for performing convolution operations, and that an object of a convolution operation performed by each convolution module is a result of a convolution operation performed by a previous convolution module, that is, the convolution model is superimposed and progressive. The result of the convolution operation performed by the convolution module of each layer may pass through a GL-GConv Resblock module (may be referred to as GL-G convolution residual block, where the GL-G is the abbreviation of Global-Local Gated, which is intended to highlight the extraction and processing of global features by the convolution residual block) which is self-constructed in the present disclosure, and the GL-G convolution residual block is obtained by improvement on the basis of a standard convolution residual block in a conventional residual network. Local features and global features may be obtained after processing of the GL-G convolution residual block, and are continuously gathered through an up-sampling module and finally used for generating an HDR image.

In the video conversion method proposed in the embodiments of the present application, the to-be-converted SDR video is first acquired; then one frame is extracted from the to-be-converted SDR video to serve as the current SDR image, the current SDR image is input into the parameter predictor and the generator, and the adjustment parameter corresponding to the current SDR image is output from the parameter predictor; the adjustment parameter is input into the generator, and the HDR image corresponding to the current SDR image is output from the generator; the above-described operations are repeatedly performed until the frames in the to-be-converted SDR video are converted into the HDR images each of which corresponds to a respective frame of the frames; and the HDR video corresponding to the to-be-converted SDR video is generated based on the HDR images corresponding to the frames. That is, in the present application, one adjustment parameter may be output from the parameter predictor, and the generator may be adjusted by using the adjustment parameter, so that the generator may output an HDR image with better effect. However, in an existing video conversion method, a scheme of reconstructing the HDR image based on the fusion of multiple images with different exposure can reconstruct multiple images with different exposure in only one scene; and a scheme of reconstructing the HDR image based on a single frame SDR image and reconstructing the HDR video based on the SDR video adopts the same reconstruction manner for the same image so that the effect is relatively poor. Because in the present application, the technical means of predicting one adjustment parameter through the parameter predictor and adjusting the generator by using the adjustment parameter are adopted, so that the following technical issues are overcome that the scheme of reconstructing the HDR image based on the fusion of multiple images with different exposure in the related art can reconstruct multiple images with different exposure in only one scene, and the scheme of reconstructing the HDR image based on the single frame SDR image and reconstructing the HDR video based on the SDR video in the related art adopts the same reconstruction manner for the same image so that the effect is relatively poor. According to the technical scheme provided in the present application, one adjustment parameter is predicted through the parameter predictor, the parameter may reflect the approximate brightness and color information of the SDR image, and then the parameter is used for adjusting the generator, so that the network is tailored to the input image, whereby a better effect may be obtained, and the universality is greater; moreover, the technical scheme of the embodiments of the present application is simple and convenient to implement, is convenient to popularize, and is wider in application range.

### Embodiment Two

FIG. 4 is a second flowchart of a video conversion method according to an embodiment of the present application. Further optimization and expansion are performed based on the above technical schemes, and the method may be combined with each optional implementation described above. As shown in FIG. 4, the video conversion method may include the following steps.

In S401, if the parameter predictor does not satisfy a convergence condition corresponding to the parameter predictor and the generator does not satisfy a convergence condition corresponding to the generator, one data pair is extracted from multiple pre-constructed data pairs to serve as a current data pair, where the data pair includes a mixture parameter, an SDR image of a first version, an SDR image of a second version, and an HDR image.

In this step, if the parameter predictor does not satisfy a convergence condition corresponding to the parameter predictor and the generator does not satisfy a convergence conditions corresponding to the generator, then the electronic device may extract one data pair from the multiple pre-constructed data pairs to serve as the current data pair, where each data pair includes the mixture parameter, the SDR image of the first version, the SDR image of the second version, and the HDR image. In an embodiment, the electronic device may first acquire multiple to-be-trained SDR videos, and then convert each SDR video of the multiple to-be-trained SDR videos into an SDR video of the first version and an SDR video of the second version, where the SDR video of the first version consists of the SDR image of the first version, and the SDR video of the second version consists of the SDR image of the second version. When the parameter predictor and the generator are trained based on the current data pair, an input image corresponding to the SDR image of the first version is first generated based on the mixture parameter and the SDR image of the first version, an input image corresponding to the SDR image of the second version is generated based on the mixture parameter and the SDR image of the second version, where the mixture parameter is a random number greater than 0 and less than 1; then the input image corresponding to the SDR image of the first version is mixed with the input image corresponding to the SDR image of the second version to obtain a mixed image of the SDR image of the first version and the SDR image of the second version; and then the parameter predictor and the generator are trained based on the HDR image and the mixed image of the SDR image of the first version and the SDR image of the second version. In an embodiment, in a model training stage, a large number of HDR videos need to be first collected, and then each video is converted into SDR videos of two versions, namely ASDR and BSDR, through two manners, namely a manner A and a manner B, where the brightness and color of the ASDR are closer to those of the HDR videos, and the effect is better; the BSDR is very dim in brightness and color and has a large difference with the HDR. During the training of the model, the input is: “λ×ASDR+(1−λ)×BSDR”, i.e., a random mixing of the ASDR and the BSDR, and a mixture parameter λ is randomly generated. Thus, a data pair of inputs λ, ASDR, BSDR and HDR can be obtained. When the model is trained, the input image is divided into two paths; one of the two paths enters the down-sampling module to be downscaled to a certain size, for example, the input size is 1024×1024, and the size is downscaled to 256×256 after passing through the down-sampling module, and then a parameter λ′ is predicted through the parameter predictor. The other path of the two paths enters the generator, the generator simultaneously receives λ′ as a parameter, and an output of the generator is a real HDR image as a monitor, so that the network can learn how to adjust the generator according to information such as brightness and color of the input SDR image so as to generate a corresponding HDR image. Meanwhile, an output λ′ of the predictor may be monitored by λ, and the output of the generator may be monitored by the real HDR image.

In S402, the parameter predictor and the generator are trained based on the current data pair until the parameter predictor satisfies the convergence condition corresponding to the parameter predictor and the generator satisfies the convergence condition corresponding to the generator.

In this step, the electronic device may train the parameter predictor and the generator based on the current data pair until the parameter predictor satisfies the convergence condition corresponding to the parameter predictor and the generator satisfies the convergence condition corresponding to the generator. In an embodiment, the electronic device may first generate the input image (λ×ASDR) corresponding to the SDR image of the first version based on the mixture parameter and the SDR image of the first version, and generate the input image ((1−λ)×BSDR) corresponding to the SDR image of the second version based on the mixture parameter and the SDR image of the second version, where the mixture parameter is a random number greater than 0 and less than 1; then the input image corresponding to the SDR image of the first version is mixed with the input image corresponding to the SDR image of the second version to obtain a mixed image of the SDR image of the first version and the SDR image of the second version; and then the parameter predictor and the generator are trained based on the HDR image and the mixed image of the SDR image of the first version and the SDR image of the second version until the parameter predictor satisfies the convergence condition corresponding to the parameter predictor and the generator satisfies the convergence condition corresponding to the generator.

In S403, a to-be-converted SDR video is acquired.

In S404, one frame is extracted from the to-be-converted SDR video to serve as a current SDR image, the current SDR image is input into the parameter predictor and the generator which are pre-trained, and an adjustment parameter corresponding to the current SDR image is output from the parameter predictor.

In S405, the adjustment parameter corresponding to the current SDR image is input into the generator, and an HDR image corresponding to the current SDR image is output from the generator, and an operation of extracting the current SDR image is repeatedly performed until frames in the to-be-converted SDR video are converted into HDR images each of which corresponds to a respective frame of the frames.

In S406, an HDR video corresponding to the to-be-converted SDR video is generated based on the HDR images corresponding to the frames.

In the video conversion method proposed in the embodiments of the present application, the to-be-converted SDR video is first acquired; then one frame is extracted from the to-be-converted SDR video to serve as the current SDR image, the current SDR image is input into the parameter predictor and the generator, and the adjustment parameter corresponding to the current SDR image is output from the parameter predictor; the adjustment parameter is input into the generator, and the HDR image corresponding to the current SDR image is output from the generator; the above-described operations are repeatedly performed until the frames in the to-be-converted SDR video are converted into the HDR images each of which corresponds to a respective frame of the frames; and the HDR video corresponding to the to-be-converted SDR video is generated based on the HDR images corresponding to the frames. That is, in the present application, one adjustment parameter may be output from the parameter predictor, and the generator may be adjusted by using the adjustment parameter, so that the generator may output an HDR image with better effect. In an existing video conversion method, a scheme of reconstructing the HDR image based on the fusion of multiple images with different exposure can reconstruct multiple images with different exposure in only one scene; and a scheme of reconstructing the HDR image based on a single frame SDR image and reconstructing the HDR video based on the SDR video adopts the same reconstruction manner for the same image so that the effect is relatively poor. Because in the present application, the technical means of predicting one adjustment parameter through the parameter predictor and adjusting the generator by using the adjustment parameter are adopted, so that the following technical issues are overcome: the scheme of reconstructing the HDR image based on the fusion of multiple images with different exposure in the related art can reconstruct multiple images with different exposure in only one scene, and the scheme of reconstructing the HDR image based on the single frame SDR image and reconstructing the HDR video based on the SDR video in the related art adopts the same reconstruction manner for the same image so that the effect is relatively poor. According to the technical scheme provided in the present application, one adjustment parameter is predicted through the parameter predictor, the parameter may reflect the approximate brightness and color information of the SDR image, and then the parameter is used for adjusting the generator, so that the network is tailored to the input image, whereby a better effect may be obtained, and the universality is greater; moreover, the technical scheme of the embodiments of the present application is simple and convenient to implement, is convenient to popularize, and is wider in application range.

### Embodiment Three

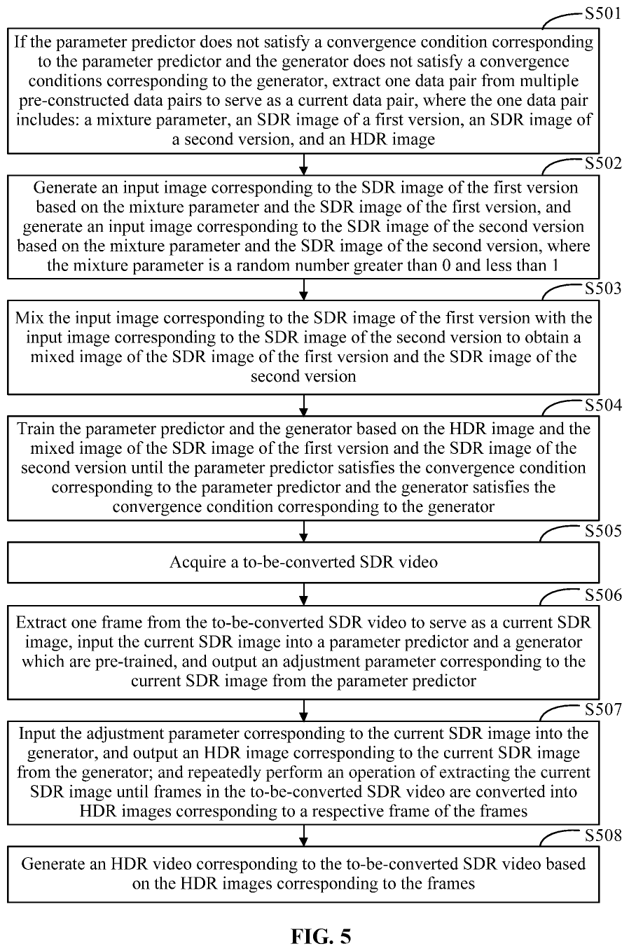

FIG. 5 is a third flowchart of a video conversion method according to an embodiment of the present application. Further optimization and expansion are performed based on the above technical schemes, and the method may be combined with each optional implementation described above. As shown in FIG. 5, the video conversion method may include the following steps.

In S501, if the parameter predictor does not satisfy a convergence condition corresponding to the parameter predictor and the generator does not satisfy a convergence conditions corresponding to the generator, one data pair is extracted from multiple pre-constructed data pairs to serve as a current data pair, where the data pair includes a mixture parameter, an SDR image of a first version, an SDR image of a second version, and an HDR image.

In this step, if the parameter predictor does not satisfy a convergence condition corresponding to the parameter predictor and the generator does not satisfy a convergence conditions corresponding to the generator, then the electronic device may extract the one data pair from the multiple pre-constructed data pairs to serve as the current data pair, where each data pair includes the mixture parameter, the SDR image of the first version, the SDR image of the second version, and the HDR image. Before this step, the electronic device may first acquire multiple to-be-trained SDR videos, and then convert each SDR video of the multiple to-be-trained SDR videos into an SDR video of the first version and an SDR video of the second version, where the SDR video of the first version consists of the SDR image of the first version, and the SDR video of the second version consists of the SDR image of the second version. The SDR video of the first version may be represented as ASDR; the SDR video of the second version may be represented as BSDR; the brightness and color of the ASDR are closer to those of the HDR video, and the effect is better; and the BSDR is very dim in brightness and color and has a large difference with the HDR.

In S502, an input image corresponding to the SDR image of the first version is generated based on the mixture parameter and the SDR image of the first version, and an input image corresponding to the SDR image of the second version is generated based on the mixture parameter and the SDR image of the second version, where the mixture parameter is a random number greater than 0 and less than 1.

In this step, the electronic device may generate the input image corresponding to the SDR image of the first version based on the mixture parameter and the SDR image of the first version, and generate the input image corresponding to the SDR image of the second version based on the mixture parameter and the SDR image of the second version, where the mixture parameter is a random number greater than 0 and less than 1. In an embodiment, the input image corresponding to the SDR image of the first version may be represented as λ×ASDR; and the input image corresponding to the SDR image of the second version may be represented as (1−λ)×BSDR.

In S503, the input image corresponding to the SDR image of the first version is mixed with the input image corresponding to the SDR image of the second version to obtain a mixed image of the SDR image of the first version and the SDR image of the second version.

In this step, the electronic device may mix the input image corresponding to the SDR image of the first version with the input image corresponding to the SDR image of the second version to obtain a mixed image of the SDR image of the first version and the SDR image of the second version. In an embodiment, the mixed image of the SDR image of the first version and the SDR image of the second version may be represented as λ×ASDR+(1−λ)×BSDR.

In S504, the parameter predictor and the generator are trained based on the HDR image and the mixed image of the SDR image of the first version and the SDR image of the second version until the parameter predictor satisfies the convergence condition corresponding to the parameter predictor and the generator satisfies the convergence condition corresponding to the generator.

In this step, the electronic device may train the parameter predictor and the generator based on the HDR image and the mixed image of the SDR image of the first version and the SDR image of the second version until the parameter predictor satisfies the convergence condition corresponding to the parameter predictor and the generator satisfies the convergence condition corresponding to the generator. In an embodiment, the electronic device may first input the mixed image of the SDR image of the first version and the SDR image of the second version into the parameter predictor and the generator, respectively; then output a predicted value of an adjustment parameter corresponding to the mixed image of the SDR image of the first version and the SDR image of the second version from the parameter predictor, and input the predicted value of the adjustment parameter into the generator; output a predicted HDR image from the generator based on the predicted value of the adjustment parameter and the mixed image of the SDR image of the first version and the SDR image of the second version; and finally, train a video conversion model based on the predicted HDR image and the HDR image.

In S505, a to-be-converted SDR video is acquired.

In S506, one frame is extracted from the to-be-converted SDR video to serve as a current SDR image, the current SDR image is input into the parameter predictor and the generator which are pre-trained, and an adjustment parameter corresponding to the current SDR image is output from the parameter predictor.

In S507, the adjustment parameter corresponding to the current SDR image is input into the generator, and an HDR image corresponding to the current SDR image is output from the generator, and an operation of extracting the current SDR image is repeatedly performed until frames in the to-be-converted SDR video are converted into HDR images each of which corresponds to a respective frame of the frames.

In S508, an HDR video corresponding to the to-be-converted SDR video is generated based on the HDR images corresponding to the frames.

In the video conversion method proposed in the embodiments of the present application, the to-be-converted SDR video is first acquired; then one frame is extracted from the to-be-converted SDR video to serve as the current SDR image, the current SDR image is input into the parameter predictor and the generator, and the adjustment parameter corresponding to the current SDR image is output from the parameter predictor; the adjustment parameter is input into the generator, and the HDR image corresponding to the current SDR image is output from the generator; the above-described operations are repeatedly performed until the frames in the to-be-converted SDR video are converted into the HDR images each of which corresponds to a respective frame of the frames; and the HDR video corresponding to the to-be-converted SDR video is generated based on the HDR images corresponding to the frames. That is, in the present application, one adjustment parameter may be output from the parameter predictor, and the generator may be adjusted by using the adjustment parameter, so that the generator may output an HDR image with better effect. In an existing video conversion method, a scheme of reconstructing the HDR image based on the fusion of multiple images with different exposure can reconstruct multiple images with different exposure in only one scene; and a scheme of reconstructing the HDR image based on a single frame SDR image and reconstructing the HDR video based on the SDR video adopts the same reconstruction manner for the same image so that the effect is relatively poor. Because in the present application, the technical means of predicting one adjustment parameter through the parameter predictor and adjusting the generator by using the adjustment parameter are adopted, so that the following technical issues are overcome: the scheme of reconstructing the HDR image based on the fusion of multiple images with different exposure in the related art can reconstruct multiple images with different exposure in only one scene, and the scheme of reconstructing the HDR image based on the single frame SDR image and reconstructing the HDR video based on the SDR video in the related art adopts the same reconstruction manner for the same image so that the effect is relatively poor. According to the technical scheme provided in the present application, one adjustment parameter is predicted through the parameter predictor, the parameter may reflect the approximate brightness and color information of the SDR image, and then the parameter is used for adjusting the generator, so that the network is tailored to the input image, whereby a better effect may be obtained, and the universality is greater; moreover, the technical scheme of the embodiments of the present application is simple and convenient to implement, is convenient to popularize, and is wider in application range.

### Embodiment Four

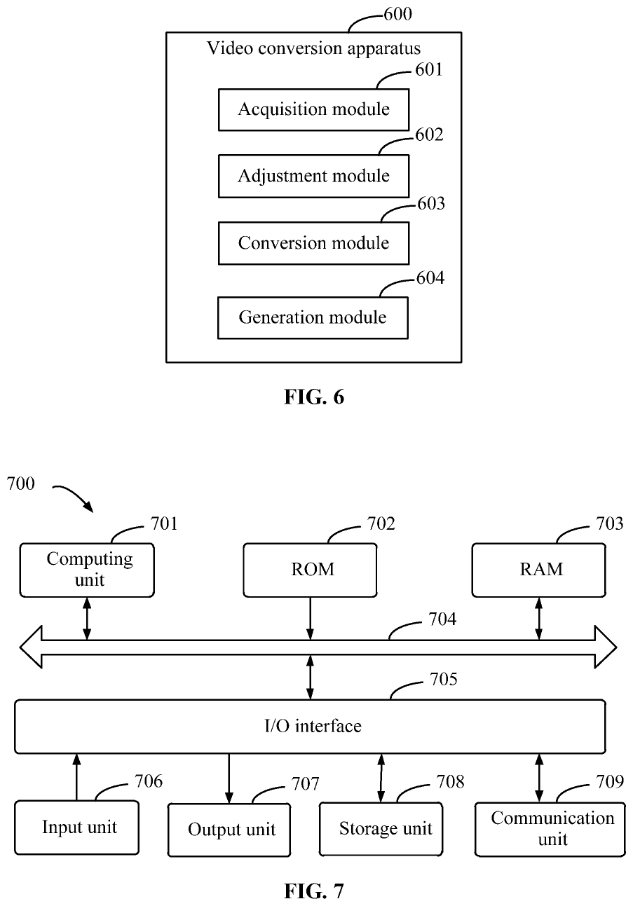

FIG. 6 is a schematic structural diagram of a video conversion apparatus according to an embodiment of the present application. As shown in FIG. 6, a video conversion apparatus 600 includes an acquisition module 601, an adjustment module 602, a conversion module 603, and a generation module 604.

The acquisition module 601 is configured to acquire a to-be-converted SDR video.

The adjustment module 602 is configured to: extract one frame from the to-be-converted SDR video to serve as a current SDR image, input the current SDR image into a parameter predictor and a generator which are pre-trained, and output an adjustment parameter corresponding to the current SDR image from the parameter predictor.

The conversion module 603 is configured to: input the adjustment parameter corresponding to the current SDR image into the generator, and output an HDR image corresponding to the current SDR image from the generator; and repeatedly perform an operation of extracting the current SDR image until frames in the to-be-converted SDR video are converted into HDR images each of which corresponds to a respective frame of the frames.

The generation module 604 is configured to generate an HDR video corresponding to the to-be-converted SDR video based on the HDR images.

Further, the apparatus further includes a training module 605 (not shown in the drawings). The training module 605 is configured to: if the parameter predictor does not satisfy a convergence condition corresponding to the parameter predictor and the generator does not satisfy a convergence conditions corresponding to the generator, extract one data pair from multiple pre-constructed data pairs to serve as a current data pair, where the one data pair includes a mixture parameter, an SDR image of a first version, an SDR image of a second version, and an HDR image; and train the parameter predictor and the generator based on the current data pair until the parameter predictor satisfies the convergence condition corresponding to the parameter predictor and the generator satisfies the convergence condition corresponding to the generator.

Further, the training module 605 is further configured to: acquire multiple to-be-trained SDR videos; convert each video of the multiple to-be-trained SDR videos into an SDR video of the first version and an SDR video of the second version, where the SDR video of the first version consists of the SDR image of the first version, and the SDR video of the second version consists of the SDR image of the second version.

Further, the training module 605 is configured to: generate an input image corresponding to the SDR image of the first version based on the mixture parameter and the SDR image of the first version, generate an input image corresponding to the SDR image of the second version based on the mixture parameter and the SDR image of the second version, where the mixture parameter is a random number greater than 0 and less than 1; mix the input image corresponding to the SDR image of the first version with the input image corresponding to the SDR image of the second version to obtain a mixed image of the SDR image of the first version and the SDR image of the second version; and train the parameter predictor and the generator based on the HDR image and the mixed image of the SDR image of the first version and the SDR image of the second version.

Further, the training module 605 is configured to: input the mixed image of the SDR image of the first version and the SDR image of the second version into the parameter predictor and the generator, respectively; output a predicted value of an adjustment parameters corresponding to the mixed image of the SDR image of the first version and the SDR image of the second version from the parameter predictor, and input the predicted value of the adjustment parameter corresponding to the mixed image of the SDR image of the first version and the SDR image of the second version into the generator; and output a predicted HDR image from the generator based on the mixed image of the SDR image of the first version and the SDR image of the second version and the predicted value of the adjustment parameter; and train a video conversion model based on the predicted HDR image and the HDR image.

Further, the training module 605 is further configured to: input the mixed image of the SDR image of the first version and the SDR image of the second version into a down-sampling module, downscale, through the down-sampling module, the mixed image of the SDR image of the first version and the SDR image of the second version to a mixed image of a predetermined size; and perform an operation of inputting the mixed image of the predetermined size into the parameter predictor.

The above-described video conversion apparatus may execute the method according to any of the embodiments of the present application, and has functional modules and beneficial effects corresponding to the performed method. For technical details not described in detail in this embodiment, reference is made to the video conversion method according to any of the embodiments of the present application.

### Embodiment Five

According to the embodiments of the present disclosure, the present disclosure further provides an electronic device, a readable storage medium and a computer program product.

FIG. 7 shows a schematic block diagram of an exemplary electronic device 700 that may be used for implementing the embodiments of the present disclosure. The electronic device is intended to represent various forms of digital computers, such as laptops, desktops, workstations, personal digital assistants, servers, blade servers, mainframe computers, and other appropriate computers. The electronic device may also represent various forms of mobile devices, such as personal digital processing, cellphones, smartphones, wearable devices, and other similar computing devices. The components shown herein, their connections and relationships between these components, and the functions of these components, are illustrative only and are not intended to limit implementations of the present disclosure described and/or claimed herein.

As shown in FIG. 7, the electronic device 700 includes a computing unit 701, the computing unit 701 may perform various appropriate actions and processes according to a computer program stored in a read-only memory (ROM) 702 or a computer program loaded from a storage unit 708 into a random-access memory (RAM) 703. The RAM 703 may also store various programs and data required for the operation of the device 700. The computing unit 701, the ROM 702, and the RAM 703 are connected to each other via a bus 604. An input/output (I/O) interface 705 is also connected to the bus 604.

Multiple components in the electronic device 700 are connected to the I/O interface 705, and the multiple components include an input unit 706 such as a keyboard or a mouse, an output unit 707 such as various types of displays or speakers, the storage unit 708 such as a magnetic disk or an optical disk, and a communication unit 709 such as a network card, a modem or a wireless communication transceiver. The communication unit 709 allows the electronic device 700 to exchange information/data with other devices over a computer network such as the Internet and/or various telecommunication networks.

The computing unit 701 may be a variety of general-purpose and/or dedicated processing assemblies having processing and computing capabilities. Some examples of the computing unit 701 include, but are not limited to, a central processing unit (CPU), a graphics processing unit (GPU), a special-purpose artificial intelligence (AI) computing chip, various computing units executing machine learning model algorithms, a digital signal processor (DSP) and any suitable processor, controller and microcontroller. The computing unit 701 performs the various methods and processes described above, such as the video conversion method. For example, in some embodiments, the video conversion method may be implemented as computer software programs tangibly embodied in a machine-readable medium, such as the storage unit 708. In some embodiments, part or all of computer programs may be loaded and/or installed on the device 700 via the ROM 702 and/or the communication unit 709. When the computer program is loaded to the RAM 703 and executed by the computing unit 701, one or more steps of the video conversion method described above may be executed. Alternatively, in other embodiments, the computing unit 701 may be configured, in any other suitable manners (e.g., by means of firmware), to perform the video conversion method.

Various implementations of the systems and technologies described above herein may be achieved in digital electronic circuit systems, integrated circuit systems, field-programmable gate arrays (FPGAs), application-specific integrated circuits (ASICs), application-specific standard products (ASSPs), systems on chip (SOCs), complex programmable logic devices (CPLDs), computer hardware, firmware, software, and/or combinations thereof. These various implementations may include implementation in one or more computer programs, and the one or more computer programs are executable and/or interpretable on a programmable system including at least one programmable processor, the programmable processor may be a special-purpose or general-purpose programmable processor for receiving data and instructions from a memory system, at least one input device and at least one output device and transmitting data and instructions to the memory system, the at least one input device and the at least one output device.

Program codes for implementing the methods of the present disclosure may be written in any combination of one or more programming languages. These program codes may be provided for the processor or controller of a general-purpose computer, a special-purpose computer, or another programmable data processing apparatus to enable the functions/operations specified in a flowchart and/or a block diagram to be implemented when the program codes are executed by the processor or controller. The program codes may be executed entirely on a machine, partly on the machine, as a stand-alone software package, partly on the machine and partly on a remote machine, or entirely on the remote machine or server.

In the context of the present disclosure, a machine-readable medium may be a tangible medium that may contain or store a program available for an instruction execution system, apparatus or device or a program used in conjunction with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any appropriate combination of the foregoing. More specific examples of the machine-readable storage medium may include an electrical connection based on one or more wires, a portable computer diskette, a hard disk, a random access memory (RAM), a read-only memory (ROM), an erasable programmable read-only memory (EPROM) or a flash memory, an optical fiber, a portable compact disc read-only memory (CD-ROM), an optical storage device, a magnetic storage device, or any appropriate combination of the foregoing.

To provide the interaction with a user, the systems and technologies described here may be implemented on a computer. The computer has a display device (such as, a cathode-ray tube (CRT) or liquid-crystal display (LCD) monitor) for displaying information to the user; and a keyboard and a pointing device (such as, a mouse or a trackball) through which the user may provide input to the computer. Other kinds of devices may also be used for providing for interaction with the user; for example, feedback provided to the user may be sensory feedback in any form (such as, visual feedback, auditory feedback, or haptic feedback); and input from the user may be received in any form (including acoustic input, speech input, or haptic input).

The systems and technologies described here may be implemented in a computing system including a back-end component (such as, a data server), or a computing system including a middleware component (such as, an application server), or a computing system including a front-end component (such as, a client computer having a graphical user interface or a web browser through which the user may interact with the implementations of the systems and technologies described herein), or a computing system including any combination of such back-end component, middleware component, or front-end component. The components of the system may be interconnected by any form or medium of digital data communication (such as, a communication network). Examples of the communication network include a local area network (LAN), a wide area network (WAN), a blockchain network, and the Internet.

The computer system may include a client and a server. The client and the server are generally remote from each other and typically interact through a communication network. The relationship of client and server arises by virtue of computer programs running on the respective computers and having a client-server relationship to each other. The server may be a cloud server, also referred to as a cloud computing server or a cloud host, and is a host product in a cloud computing service system, so that the defects of high management difficulty and weak service expansibility in the traditional physical host and VPS service are overcome.

It should be understood that various forms of the flows shown above, reordering, adding or deleting steps may be used. For example, the steps described in the present disclosure may be executed in parallel, sequentially or in different orders as long as the desired result of the technical scheme disclosed in the present application may be achieved. In the technical schemes of the present disclosure, the acquisition, storage and application of the involved personal information of the user are in compliance with the provisions of relevant laws and regulations, and do not violate the common customs of public sequences.

The above implementations should not be construed as limiting the protection scope of the present disclosure. It should be understood by those skilled in the art that various modifications, combinations, sub-combinations and substitutions may be made, depending on design requirements and other factors. Any modification, equivalent replacement, and improvement made within the spirit and principle of the present disclosure should be included within the protection scope of the present disclosure.

What is claimed is:

1. A video conversion method, comprising:
acquiring a to-be-converted standard dynamic range (SDR) video;
extracting one frame from the to-be-converted SDR video to serve as a current SDR image, inputting the current SDR image into a parameter predictor and a generator which are pre-trained, and outputting an adjustment parameter corresponding to the current SDR image from the parameter predictor;
inputting the adjustment parameter corresponding to the current SDR image into the generator, and outputting a high dynamic range (HDR) image corresponding to the current SDR image from the generator; and repeatedly performing an operation of extracting the current SDR image until frames in the to-be-converted SDR video are converted into HDR images each of which corresponds to a respective frame of the frames; and
generating an HDR video corresponding to the to-be-converted SDR video based on the HDR images.

2. The method of claim 1, wherein before acquiring the to-be-converted SDR video, the method further comprises:
in a case where the parameter predictor does not satisfy a convergence condition corresponding to the parameter predictor and the generator does not satisfy a convergence condition corresponding to the generator, extracting one data pair from a plurality of pre-constructed data pairs to serve as a current data pair, wherein the one data pair comprises: a mixture parameter, an SDR image of a first version, an SDR image of a second version, and an HDR image; and
training the parameter predictor and the generator based on the current data pair, and repeatedly performing operations of extracting the current data pair and training the parameter predictor and the generator until the parameter predictor satisfies the convergence condition corresponding to the parameter predictor and the generator satisfies the convergence condition corresponding to the generator.

3. The method of claim 2, further comprising:
acquiring a plurality of to-be-trained SDR videos;
converting each SDR video of the plurality of to-be-trained SDR videos into an SDR video of the first version and an SDR video of the second version, wherein the SDR video of the first version consists of the SDR image of the first version, and the SDR video of the second version consists of the SDR image of the second version.

4. The method of claim 2, wherein training the parameter predictor and the generator based on the current data pair comprises:
generating an input image corresponding to the SDR image of the first version based on the mixture parameter and the SDR image of the first version, and generating an input image corresponding to the SDR image of the second version based on the mixture parameter and the SDR image of the second version, wherein the mixture parameter is a random number greater than 0 and less than 1;
mixing the input image corresponding to the SDR image of the first version with the input image corresponding to the SDR image of the second version to obtain a mixed image of the SDR image of the first version and the SDR image of the second version; and
training the parameter predictor and the generator based on the mixed image of the SDR image of the first version and the SDR image of the second version and the HDR image that is included in the one data pair.

5. The method of claim 4, wherein training the parameter predictor and the generator based on the mixed image of the SDR image of the first version and the SDR image of the second version and the HDR image that is included in the one data pair comprises:
inputting the mixed image into the parameter predictor and the generator, respectively;
outputting a predicted value of an adjustment parameter corresponding to the mixed image from the parameter predictor, and inputting the predicted value of the adjustment parameter corresponding to the mixed image into the generator;
outputting a predicted HDR image from the generator based on the mixed image and the predicted value of the adjustment parameter corresponding to the mixed image; and
training a video conversion model based on the predicted HDR image and the HDR image that is included in the one data pair.

6. The method of claim 5, wherein before inputting the mixed image into the parameter predictor, the method further comprises:
inputting the mixed image into a down-sampling module, downscaling, through the down-sampling module, the mixed image to a mixed image of a predetermined size, and performing an operation of inputting the mixed image of the predetermined size into the parameter predictor.

7. An electronic device, comprising:
at least one processor; and
a memory communicatively connected to the at least one processor;
wherein the memory stores an instruction executable by the at least one processor, and the instructions, when executed by the at least one processor, causes the at least one processor to perform:
acquiring a to-be-converted standard dynamic range (SDR) video;
extracting one frame from the to-be-converted SDR video to serve as a current SDR image, inputting the current SDR image into a parameter predictor and a generator which are pre-trained, and outputting an adjustment parameter corresponding to the current SDR image from the parameter predictor;
inputting the adjustment parameter corresponding to the current SDR image into the generator, and outputting a high dynamic range (HDR) image corresponding to the current SDR image from the generator; and repeatedly performing an operation of extracting the current SDR image until frames in the to-be-converted SDR video are converted into HDR images each of which corresponds to a respective frame of the frames; and
generating an HDR video corresponding to the to-be-converted SDR video based on the HDR images.

8. The electronic device of claim 7, wherein the instructions, when executed by the at least one processor, causes the at least one processor to, before acquiring the to-be-converted SDR video, further perform:
in a case where the parameter predictor does not satisfy a convergence condition corresponding to the parameter predictor and the generator does not satisfy a convergence condition corresponding to the generator, extracting one data pair from a plurality of pre-constructed data pairs to serve as a current data pair, wherein the one data pair comprises: a mixture parameter, an SDR image of a first version, an SDR image of a second version, and an HDR image; and
training the parameter predictor and the generator based on the current data pair, and repeatedly performing operations of extracting the current data pair and training the parameter predictor and the generator until the parameter predictor satisfies the convergence condition corresponding to the parameter predictor and the generator satisfies the convergence condition corresponding to the generator.

9. The electronic device of claim 8, wherein the instructions, when executed by the at least one processor, causes the at least one processor to further perform:
acquiring a plurality of to-be-trained SDR videos;
converting each SDR video of the plurality of to-be-trained SDR videos into an SDR video of the first version and an SDR video of the second version, wherein the SDR video of the first version consists of the SDR image of the first version, and the SDR video of the second version consists of the SDR image of the second version.

10. The electronic device of claim 8, wherein the instructions, when executed by the at least one processor, causes the at least one processor to perform training the parameter predictor and the generator based on the current data pair in the following way:
generating an input image corresponding to the SDR image of the first version based on the mixture parameter and the SDR image of the first version, and generating an input image corresponding to the SDR image of the second version based on the mixture parameter and the SDR image of the second version, wherein the mixture parameter is a random number greater than 0 and less than 1;
mixing the input image corresponding to the SDR image of the first version with the input image corresponding to the SDR image of the second version to obtain a mixed image of the SDR image of the first version and the SDR image of the second version; and
training the parameter predictor and the generator based on the mixed image of the SDR image of the first version and the SDR image of the second version and the HDR image that is included in the one data pair.

11. The electronic device of claim 10, wherein the instructions, when executed by the at least one processor, causes the at least one processor to perform training the parameter predictor and the generator based on the mixed image of the SDR image of the first version and the SDR image of the second version and the HDR image that is included in the one data pair in the following way:
inputting the mixed image into the parameter predictor and the generator, respectively;
outputting a predicted value of an adjustment parameter corresponding to the mixed image from the parameter predictor, and inputting the predicted value of the adjustment parameter corresponding to the mixed image into the generator;
outputting a predicted HDR image from the generator based on the mixed image and the predicted value of the adjustment parameter corresponding to the mixed image; and
training a video conversion model based on the predicted HDR image and the HDR image that is included in the one data pair.

12. The electronic device of claim 11, wherein the instructions, when executed by the at least one processor, causes the at least one processor to, before inputting the mixed image into the parameter predictor, further perform:
inputting the mixed image into a down-sampling module, downscaling, through the down-sampling module, the mixed image to a mixed image of a predetermined size, and performing an operation of inputting the mixed image of the predetermined size into the parameter predictor.

13. A non-transitory computer readable storage medium storing a computer instruction, wherein the computer instruction is configured to cause a computer to perform:
acquiring a to-be-converted standard dynamic range (SDR) video;
extracting one frame from the to-be-converted SDR video to serve as a current SDR image, inputting the current SDR image into a parameter predictor and a generator which are pre-trained, and outputting an adjustment parameter corresponding to the current SDR image from the parameter predictor;
inputting the adjustment parameter corresponding to the current SDR image into the generator, and outputting a high dynamic range (HDR) image corresponding to the current SDR image from the generator; and repeatedly performing an operation of extracting the current SDR image until frames in the to-be-converted SDR video are converted into HDR images each of which corresponds to a respective frame of the frames; and
generating an HDR video corresponding to the to-be-converted SDR video based on the HDR images.

14. The non-transitory computer readable storage medium of claim 13, wherein the computer instruction is configured to cause the computer to, before acquiring the to-be-converted SDR video, further perform:
in a case where the parameter predictor does not satisfy a convergence condition corresponding to the parameter predictor and the generator does not satisfy a convergence condition corresponding to the generator, extracting one data pair from a plurality of pre-constructed data pairs to serve as a current data pair, wherein the one data pair comprises: a mixture parameter, an SDR image of a first version, an SDR image of a second version, and an HDR image; and
training the parameter predictor and the generator based on the current data pair, and repeatedly performing operations of extracting the current data pair and training the parameter predictor and the generator until the parameter predictor satisfies the convergence condition corresponding to the parameter predictor and the generator satisfies the convergence condition corresponding to the generator.

15. The non-transitory computer readable storage medium of claim 14, wherein the computer instruction is configured to cause the computer to further perform:
acquiring a plurality of to-be-trained SDR videos;
converting each SDR video of the plurality of to-be-trained SDR videos into an SDR video of the first version and an SDR video of the second version, wherein the SDR video of the first version consists of the SDR image of the first version, and the SDR video of the second version consists of the SDR image of the second version.

16. The non-transitory computer readable storage medium of claim 14, wherein the computer instruction is configured to cause the computer to perform training the parameter predictor and the generator based on the current data pair in the following way:
generating an input image corresponding to the SDR image of the first version based on the mixture parameter and the SDR image of the first version, and generating an input image corresponding to the SDR image of the second version based on the mixture parameter and the SDR image of the second version, wherein the mixture parameter is a random number greater than 0 and less than 1;
mixing the input image corresponding to the SDR image of the first version with the input image corresponding to the SDR image of the second version to obtain a mixed image of the SDR image of the first version and the SDR image of the second version; and
training the parameter predictor and the generator based on the mixed image of the SDR image of the first version and the SDR image of the second version and the HDR image that is included in the one data pair.

17. The non-transitory computer readable storage medium of claim 16, wherein the computer instruction is configured to cause the computer to perform training the parameter predictor and the generator based on the mixed image of the SDR image of the first version and the SDR image of the second version and the HDR image that is included in the one data pair in the following way:
inputting the mixed image into the parameter predictor and the generator, respectively;
outputting a predicted value of an adjustment parameter corresponding to the mixed image from the parameter predictor, and inputting the predicted value of the adjustment parameter corresponding to the mixed image into the generator;
outputting a predicted HDR image from the generator based on the mixed image and the predicted value of the adjustment parameter corresponding to the mixed image; and
training a video conversion model based on the predicted HDR image and the HDR image that is included in the one data pair.

18. The non-transitory computer readable storage medium of claim 17, wherein the computer instruction is configured to cause the computer to, before inputting the mixed image into the parameter predictor, further perform:
inputting the mixed image into a down-sampling module, downscaling, through the down-sampling module, the mixed image to a mixed image of a predetermined size, and performing an operation of inputting the mixed image of the predetermined size into the parameter predictor.
